(19) United States
(12) Patent Application Publication
(10) Pub. No.: US 2004/0002790 A1
(43) Pub. Date: Jan. 1, 2004

(54) Sensitive devices and sensitive applications

(76) Inventor: Paul Senn, Swampscott, MA (US)

Correspondence Address: Paul Senn, 1121 Hinman, Evanston, IL, 60202, US

(21) Appl. No.: 10/185,921

(22) Filed: Jun. 28, 2002

(51) Int. Cl. G05B 19/04; G05B 13/02; G06F 19/00; G06F 17/00; G06N 5/02

(52) U.S. Cl. 700/246; 700/29; 700/245; 706/46

(57) ABSTRACT

A method for building a new generation of computer applications termed “Sensitive Applications” is described. These applications have the potential to give the impression of working towards goals, reacting “emotionally” and “understanding” feelings. Sensitive Applications take as their input the rate and direction of change of subjective information (such as emotional tone). Sensitive Applications are capable of self-adjustment in efforts to increase the frequency of “good” behaviors (ie behaviors which seem to increase the possibility of reaching a goal.) They are capable of a wide range of modes of expression; through the use of mathematical and geometrical constructs such as waves and lines, the flow and change of emotional states is represented. The invention makes it possible to define a Behavior and then implement the manifestation of this behavior differently for different devices. The invention can be used in combination with robotics to create “Sensitive Devices”, such as a toy which gives the impression of being very knowledgeable, emotional, interested and alive.

### BACKGROUND OF THE INVENTION

A method for building a new generation of computer applications termed “Sensitive Applications” is described. These applications have the potential to give the impression of working towards goals, reacting “emotionally” and “understanding” feelings. They are unique in that they take as their input the rate and direction of change of subjective information (such as emotional tone). Sensitive Applications are capable of self-adjustment in efforts to increase the frequency of “good” behaviors (ie behaviors which seem to increase the possibility of reaching a goal.) They are capable of a wide range of modes of expression; through the use of mathematical and geometrical constructs such as waves and lines, the flow and change of emotional states is represented. The invention makes it possible to define a Behavior and then implement the manifestation of this behavior differently for different devices. Examples of applications which might be created using this invention are new types of interactive multimedia presentations (in which the presentation itself changes every time it is given as the emotional content of the material changes, “buddy” applications (which converse with the user on a chosen domain, and react differently as the information relevant to this domain changes), and a controller which sets alarm levels on a building alarm system according to the tenseness of a political situation measured through searches of news bulletins on the internet. The invention can be used in combination with robotics and animatronics technologies to create “Sensitive Devices”, such as a toy which gives the impression of being very knowledgeable, emotional, interested and alive.

Extensive effort has been made to make devices and applications “Intelligent”, with varying degrees of success. Perhaps the pinnacle of this type of work in the area of Robotics is demonstrated by the devices deployed in space by NASA, such as the Mars Pathfinder/Sojourner. Significant work has also gone into the field of Knowledge Representation, leading to systems which can “understand” your question and attempt to answer it (such as the “Ask Jeeves” Web search engine system). However less work has gone into the computer representation of subjective human states of consciousness, ie emotional states. The focus of this invention is on making devices and applications both “knowledgeable” and “sensitive” (that is, appearing to react to changes in emotional tone of input and progressing through various subjective “states of mind” such as angry, sad, etc). This invention puts forward a new way to drive application and device Behaviors, using subjective information dimensions such as emotional tone, and the rate and direction of change of these dimensions. The invention can be used in conjunction with technologies described in patent application Ser. No. 09/547,291 entitled “Web-based Information Content Analyzer and Information Dimension Dictionary”, Inventor: Paul Senn. The system described in that patent application will heretoforth be referred to as the Web-based Information Content Analyzer System or WICA system. The invention can function independently of the WICA system, however. The WICA system simply provides a source of input in the form of search results which have been analyzed and rated for an Information Dimension within an Information Domain. Other systems which provide rated search results could also be used as input for this invention.

The invention makes it possible to create Sensitive Applications by first selecting Information Domains, adding criteria for chosen Information Dimensions (such as emotional tones), and then mapping probabilities of application behaviors to changes in those dimensions. For example, suppose we wanted to create a doll which is an Olympic figure skating fan. We want the doll to react to news about figure skating, and to have a favorite skater whose life is of interest to the doll. We would like the doll to express its interest in skating orally, via speech. So we would create a Sensitive Application which drives the behavior of the doll, therebye turning the doll into a Sensitive Device. The information domain chosen is “Olympic figure skating”. A domain of special interest within Olympic Skating would be “Favorite Olympic Skater”. It is possible using current commercially available technology to give our Olympic figure skating fan text to speech capability. For this application, we could map emotional tone to application behaviors by specifying different text to speech algorithms for different emotional tones, resulting in the doll having a sad voice on some occasions, a happy voice on others, etc. The purchaser of the doll could input the name of their favorite skater. Suppose it was Tara Lipinsky. The application developer would have programmed the application so that when the rate of positive references to the Tara Lipinsky was going up, the toy would speak in a happy voice about Tara Lipinsky (repeating facts gleaned from the Internet using text to speech conversion). And when Tara's popularity seemed to be declining, the toy would speak more sadly. To make this behavior possible, the toy would be connected to the Internet, and have access to a Content Retrieval Engine and Content Analysis Engine (described in detail in the WICA system patent application Ser. No. 09/547,291), as well as a Rate of Change Analysis Engine and a Behavior Driver (which are new software components described herein). The term we will use for Sensitive Applications connected to an external network such as the Internet is “Net-sensitive” Applications. The devices which are controlled by Net-Sensitive Applications are thereby Net-Sensitive Devices. This invention describes a new method for relating Ratings (and changes of ratings) and other measures within information dimensions to Device Behaviors (such as generation of speech in a certain tone of voice). There are a wide variety of Behaviors which are possible by taking advantage of existing technologies, for-instance, in the area of robotics. In the case of our doll, the subsystem which expresses the emotional content could do so using the text to speech capability as described above, or using other methods. For-instance the Net-sensitive Device could contain a video display which could display both text and images (including dvd movies, etc) or could contain servo hardware which drives mechanical things such as arms, legs, etc. The Behavior called “sadness” could manifest itself very differently for different devices. For-instance, if instead of a doll, the Olympic Skating Fan could simply be a program running on a PC, in which case sadness might be reflected by the screen color being various shades of blue. It is our view that the work which has been done to make computers seem “smarter” has not yielded life-like applications because what is needed are not new techniques in machine “Intelligence” but new techniques for machine “sensitivity”. This includes the need to give application developers tools to implement behaviors which progress, ebb and flow the way human emotions do. This invention provides a new set of techniques in this area.

### SUMMARY OF THE INVENTION

To illustrate the invention, let us consider an application which was designed to be a “buddy” for an individual with say, an interest in the game of chess. Such an application might be useful for someone with a passion for chess who could not always find available people to share his interest. Although all of the multimedia capabilities described above could be used, let us consider for simplicity the case of a standard video display and keyboard as the user interface. Our goal is to make the application simulate a keen interest in chess, tell the user interesting things about chess, express opinions about chess and react “emotionally” to news about chess. The Sensitive Application developer would first need to determine the information domains of interest required to implement such an application. Here is a possible selection of these items:

Information Domain: Chess

Domains within Chess: American Chess Players, Kids Chess Tournaments, International Chess.

The developer would then select the Information Dimensions, Behavior Triggers and Application Behaviors for each selected domain. The tables below illustrate what we mean by each of these terms: A Behavior Trigger consists of a set of conditions. If the conditions are met (for-instance, a set of positive articles about Chess appeared on the World Wide Web), the Behavior Trigger is activated and the probability for the Application Behavior is calculated. The Rate of Change Analysis Engine (RCAE) is responsible for determining if any Behavior Trigger Conditions are met. The results of this analysis is passed on to the Behavior Driver. The RCAE also keeps a history of which Behavior Trigger Conditions have been met (Trigger History). There may be a set of Conditions which we would like the application to consider “desirable”. To implement a goal-oriented behavior, the invention makes it possible to use the Trigger History to look for correlations between Behaviors it has generated in the past, and occurrences of desirable outcomes. The system can then modify its own parameters (specifically the probability that certain Behaviors will be activated) to make the Triggers which seem to be correlated with desirable results occur more frequently.

The Behavior Driver produces the correct set of instructions for the device to implement the Behavior specified by a Trigger. Behavior Trigger Conditions are defined in the Behavior Trigger Table. FIG. 1a shows an example of a Behavior Trigger Table for the Chess buddy Application. Examining the first entry in this table, this entry may be interpreted as follows: If there is more than a 20% change in the rating for Positive Emotional Tone in User Input Search Results in the domain of Chess over a 24 hour period, than there is an 80% probability that a change in mood will be triggered (an increase in the intensity of “Happy” Mood). The Mood will last for a period of 40 time units. The Probability entry is used here to make it possible to adjust the frequency of occurrence of the Behavior dynamically, and to introduce an element of uncertainty or randomness into the process of determining Behaviors. These are, after all “sensitive” applications, and the developer may want to make the application exhibit the same kind of unpredictable volativity which is seen in human emotion. (Of course, this element of probability can be eliminated by simply setting the probability to 1.0 in the table entry). In addition to being used to create this sense of emotional volatility, this probability can be “self-adjusted” by the system, which is the capability used to create goal-oriented Behavior in the Sensitive Application.

The second table entry states that if the CompositeRating for PositiveTone in the American Chess Players Information Domain exceeds 90 for External Input Search results (such as World Wide Web searches), the Intensity of the Mood named “Excited” should be increased by +30 for a period of 10 time units (could be seconds or whatever the system developer desires).

The third table entry states that if the CompositeRating for PositiveTone in the Russian Chess Players Information Domain exceeds 90 AND the ConfidenceLevel in this rating exceeds 0.50, the Reaction named “Upset” should be activated with an Intensity of 7 for a period of 20 time units.

Another unique feature of the invention is that both Triggers and Probabilities can be based on formulae rather than single parameters or absolute numeric values. For-instance the probability of a given behavior could be set equal to (Confidence Level * 1.1) , with a max value of 1.0 Confidence Level is a term defined in the WICA system which simply provides an indicator of how confident the system is that the given rating is correct. The Confidence Level is a number between 0 and 1. This formula would make the probability of a behavior more and more likely as our confidence that the rating was correct increased.

The application to implement the functionality for the Chess buddy would include the following:

1. A Content Retrieval Engine (CRE) with Content Retrieval Objects (CROS) as required for each domain. An example of a Content Retrieval Object for “International Chess” would be an object which looks for references to “John Blumenthal”, since he is known to be a past president and active member of the International Chess organization.

2. A Content Analysis Engine (CAE) with Content Analysis Objects (CAOs) for Emotional Tone. Other CAOs might be created for dimensions like Quality and Cooperation. The Content Analysis Objects provide a rating (a number from 1 to 100) and a Reference count which indicates the level of each of these dimensions (and number of search hits on which this level was based). The lower the rating, the lower the level of quality or cooperation (or a more negative emotional tone).

3. A Rate of Change Analysis Engine (RCAE) which compares results of Content Analysis over a period of time for selected information domains and information dimensions.

4. A Behavior Driver. The Behavior Driver contains the program logic to take specific actions based on the results returned from the Rate of Change Analysis Engine and Content Analysis Engine.

The Content Retrieval Engine and Content Analysis Engine are described in the WICA System patent application (Ser. No. 09/547,291). The Rate of Change Analysis Engine (RCAE) is a new component, as is the Behavior Driver. A high level diagram of the Information flow between these components is provided in FIG. 2.

The purpose of the RCAE component is to provide a mechanism for monitoring and measuring changes in ratings for given information dimensions and domains, and to determine what Behaviors are appropriate given these ratings.

The RCAE uses Analyzed Search Results obtained from the Content Analysis Engine and administrative tables which map ratings to Behaviors to make this determination. The RCAE produces Behavior Probability Objects as output, which can be used by a Behavior Driver to determine the right set of instructions to send to the device. As mentioned above, the RCAE does not set hard and fast instructions for Behaviors, but rather dictates probabilities. These probabilities are encapsulated in the Behavior Probability Objects. The Behavior Driver maps the instructions from the RCAE to the current device state and device capabilities, determines the final set of specific instructions which should be sent to the device given this information, and sends the commands to the device. The Behavior Driver publishes the results of its processing in the form of Behavior Summary Objects (BSOs). BSOs can be accepted as input by the CRE, and can be used by Sensitive Applications to implement a feedback loop within one application, or to transmit information between Sensitive Applications, so that one may influence the other. This information flow is described in FIG. 2.

### BRIEF DESCRIPTION OF THE DRAWINGS

The following drawings are included to describe the invention:

FIG. 1a is a sample Behavior Trigger Table.

FIG. 1b is a sample Device Characteristics Table.

FIG. 1c is a sample Goal Table.

FIG. 2 is a flowchart which shows the information flow between the Content Retrieval Engine (CRE), Content Analysis Engine (CAE), Rate of Change Analysis Engine (RCAE), Behavior Driver and Device.

FIG. 3 is a schematic showing the major system components of the invention.

FIG. 4 is a sample configuration in which the components of the invention are split between the device (in this case a wireless phone) and servers available via a network connection.

FIG. 5 is a flowchart which describes the processing done by the Rate of Change Analysis Engine.

FIG. 6 is a flowchart which describes the processing done by the Behavior Driver.

### DETAILED DESCRIPTION OF THE INVENTION

The WICA system describes the concept of Information Domain and Information Dimension. An Information Domain is a subject area (such as Chess, Microsoft, NASDAQ or MTV) and an Information Dimension is a subjective concept such as emotional tone (Happy, sad, sluggish, enthusiastic, etc) “Quality” is also an example of an Information Dimension, as there is a subjective component to the determination of quality. The current invention allows the user or administrator of the system to enter criteria which affect the probability of a given set of behaviors to be manifested for a given device. This criteria can include measurements of the strength of one or more particular Information Dimensions within one or more Information Domains, as described in the WICA system. The criteria can also include items such as Confidence Level (the degree of confidence the WICA system has in the accuracy of a given rating) and Reference Count(a measure of the number of items the rating is based on) The logic of the system is implemented in a portable software technology, and the device-side logic can be deployed in virtually any device, ranging from a laptop computer to a lamp, to a toaster, to a stuffed animal. The possible behaviors will vary accordingly. So, for-instance, assuming a lamp was equipped with a dimmer and attached to a microprocessor running the device-side logic described herein, and assuming the lamp was equipped with internet access, the user could enter criteria such that the intensity of the light produced by the lamp would vary according to the change in positive references to Microsoft on the Internet. The software which communicates with the device to instruct it to manifest certain behaviors (such as setting the intensity of the lamp) is the Behavior Driver. Sensitive devices are capable of manifesting behavior based on analyzing information from any one of (or combination of) the following sources:

a. External Input—Input from a network such as the Internet or an Intranet. Note that if the Sensitive Device makes information available via a network connection, this information can be used as input by both the originating Sensitive Application and others, so Net-Sensitive Devices and Applications can communicate with and influence one another.

b. Internal input—Input from the device to the Behavior driver (such as the current state of the device, ie the intensity of the light in the lamp example above) or from the Behavior Driver to the Content Retrieval Engine (to implement a feedback mechanism wherebye the behaviors sent to a device are input into the search process and influence future choices made by the RCAE)

c. User input—Input from a human user (such as user input via a keyboard or controls on the device).

A Sensitive device may also use any one of the input paths described above as an output path. Sensitive Applications which are capable of External input are referred to as Net-Sensitive Applications. If a Device is controlled by a Net-Sensitive Application, it is a Net-Sensitive Device. The Behavior driver controls the device according to a set of probabilities. These probabilities are set by the Rate of Change Analysis Engine (RCAE), based on a table populated by a System Administrator. The RCAE analyzes input from the various sources (External, internal and user) in order to determine the probabilities used by the Behavior Driver. Like the CAE and CRE, Both the RCAE and the Behavior Driver utilize information gained from control tables during processing. These tables are edited through an Administrative Interface. The Behavior Trigger Table is the table used by the RCAE to determine probabilities for various behaviors depending on whether Trigger Conditions have been satisfied. The Behavior Driver maps the probabilities received from the RCAE to device instructions.

The Device Characteristics Table is used by the Behavior Driver to do this mapping. A complete implementation of the system (hardware and software) for a Net-Sensitive device with Internal and user input capabilities as well as external input capabilties could therefore consist of the following components:

1) A User I/O Processing Subsystem

2) An Internal I/O Processing Subsystem

3) An External I/O Processing Subsystem

4) A WICA system, consisting of a Content Analysis Engine and a Content Retrieval System.

5) A Rate of Change Analysis Engine, including a Behavior Trigger Table

6) A Behavior Driver, including a Device Characteristics Table

7) An Administrative Interface

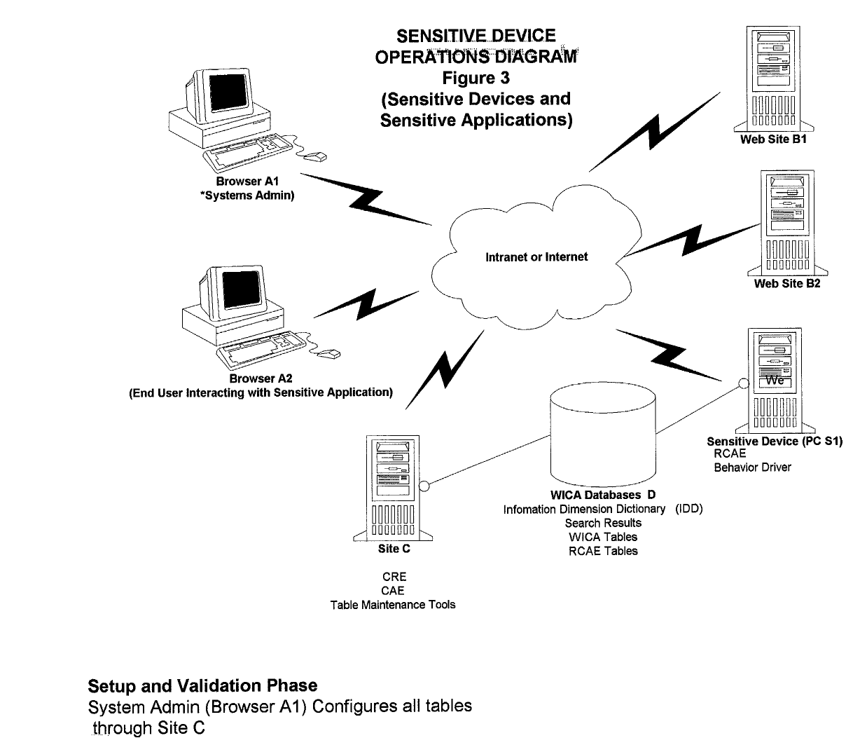

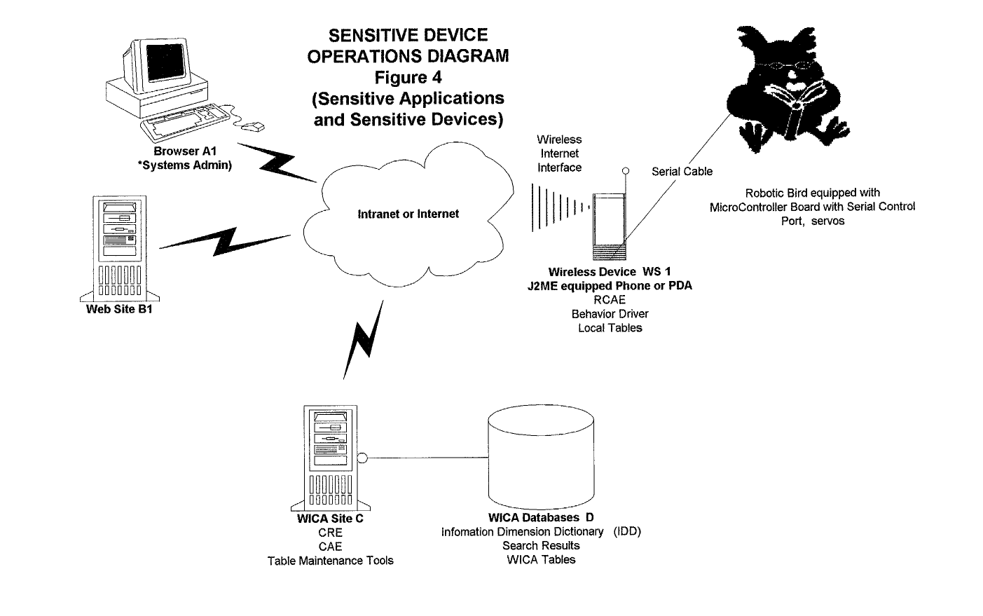

These components are diagrammed in FIG. 3. Note that the Net-Sensitive Device could be a PC, in which case components 1, 2 and 3 above are the standard Subsystems which may exist on a PC. The User I/O Processing Subsystem in this case might consist of the keyboard, monitor and mouse subsystems. Other User I/O capabilities might exist as well, such as a microphone input, or biometric device capabilities. Components 1, 2, and 3 above are all common components of a PC and do not ordinarily require separate descriptions, one can simply refer to a PC and the inclusion of these components is understood. However, note that the.Net-Sensitive device could be, for-instance, a lamp connected to a dimmer controlled by a microcontroller board. In this case the User I/O subsystem may be be simply a switch which supplies power to the device, or the controller may support keybaord input. The internal I/O processing system could be one or more serial ports on the board and associated software drivers. The External I/O subsystem could be an Ethernet port, or an 802.11 port (supporting wireless networking) and associated drivers and TCP/IP implementation. Alternatively, the Net-Sensitive Device could consist of a wireless phone or PDA connected to device such as a stuffed, animal, equipped with servos to move the limbs of the animal. In this case the User I/O subsystem is the keyboard and microphone of the device, the Internal I/O subsystem is the communication hardware and software supporting the serial port on the device, and the External I/O subsystem is the wireless voice and data networking subsystem on the device. An example of a configuration like this using a phone which is “java-enabled” ie capable of running code written in Java 2 Micro Edition (J2ME) is shown in FIG. 4. Other systems which provide for “device-side” object oriented programming logic (such as the Binary Runtime Execution Environment (BREW) sponsored by QualComm, inc.) could also be used to implement the system.

The hardware configurations as described thus far are not unique, and are commonly used in robotics and the emerging internet appliance field. The uniqueness of the invention lies in the control of these systems by software Components 4-7 above (the Web-Intelligent Content Analysis (WICA) System, the Rate of Change Analysis Engine (RCAE), the Behavior drive and the Administrative Interface. These additional components allow the device to exhibit “behavior” based on information dimensions such as emotional tone. The flexibility of the system allows it to be programmed such that the Behavior exhibited by the device will not be identical for the same input at all times, just as people do not exhibit the same emotional reactions to the same information every time it is presented. Also, the progression of emotional states can be reflected as a progression of behaviors on the device. In all of the configurations described Components 4-7 may either be implemented on the Net-Sensitive device or on a computer system available to the device, or with the components split between these two configurations. This flexibility is possible because components 4-7 can be implemented using the Java programming language (although as stated above other object oriented programming languages such as C++ could also be used), and Java runs on all of the configurations described here. Also existing distribued system protocols (such as Simple Object Access Protocol (SOAP) or Remote Method Invocation (RMI) can be used between components so that they do not have to run on the same processor, but can pass results and status to each other via a network connection. So for-instance in the Robotic Bird example (FIG. 4) the WICA system and Administrative interface run on a server available via an internet connection, while the RCAE and Behavior Driver run directly on the Wireless device controlling the bird. The tables used by the RCAE and Behavior Driver can be implemented in the form of local storage supported by the particular device. For example, in the case of a java-enabled wireless device, the local storage functions provided as part of the Java 2 Micro Edition Mobile Information Device Profile (MIDP) can support the necessary tables.

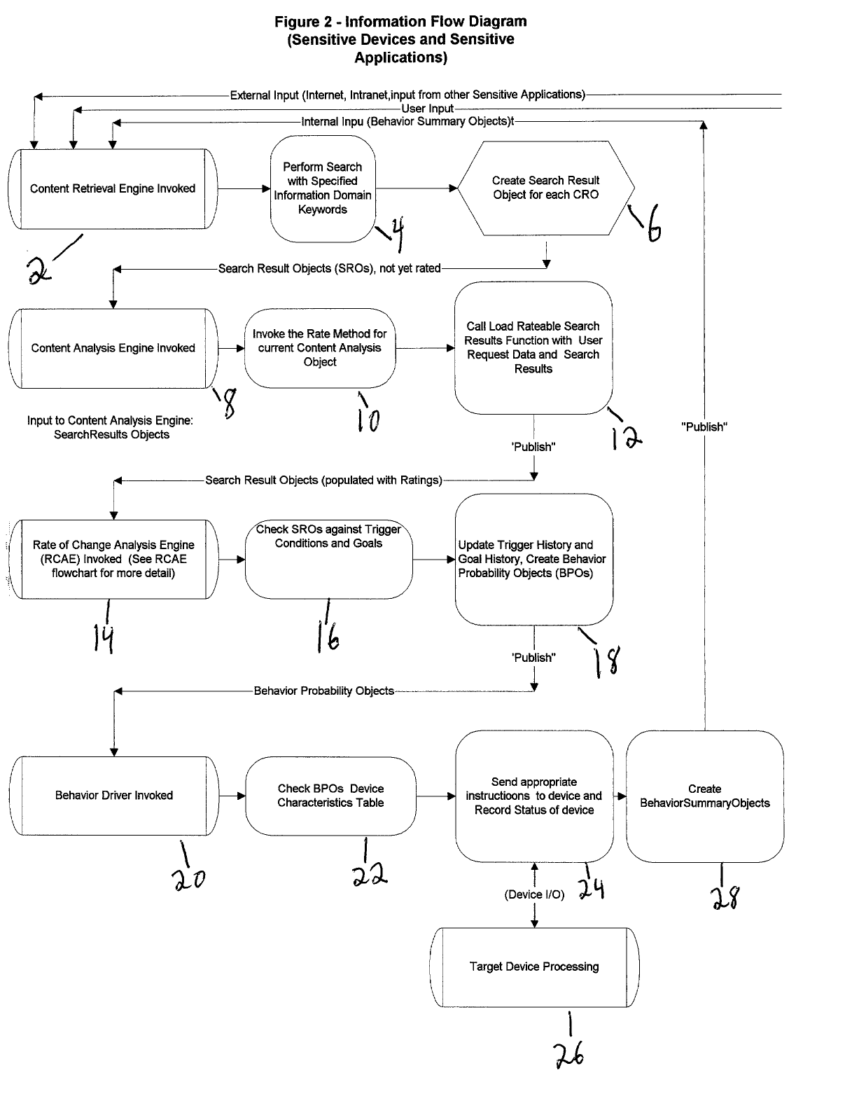

In FIG. 2, the overall processing flow is described. The steps during normal operation are as follows:

a. One or more Content Retrieval Object (CROs) retrieves information for selected Information Dimensions and Information Domains, and creates Search Result Objects (SROS) containing the relevant information (Blocks 2-6).

b. One or more Content Analysis Objects analyze the SROs created in step a, and provides ratings for the search results in selected Information Dimensions and Information Domains. These results are made available to the Rate of Change Analysis Engine (RCAE) (Blocks 8-12).

c. The RCAE compares the Rated SROs and any new Behavior Summary Objects against previous Search Results as well as a set of Trigger Conditions defined in a Behavior Trigger Table, and creates Behavior Probability Objects (BPOs) for any satisfied Trigger Conditions. These results are made available to the Behavior Driver (Blocks 14-18).

d. The Behavior Driver formulates the correct instructions to send to the Target Device based on the BPOs and information in the Device Characteristics Table. These instructions are sent to the Target Device(s) (Blocks 20-24).

e. The Target Device(s) attempt(s) to execute the instructions, and reports status back to the Behavior Driver (Blocks 24-26).

f. The Behavior Driver publishes the processing results as Behavior Summary Objects (Block 28).

The Content Retrieval Engine and Content Analysis Engine are described in the WICA patent application (Ser. No. 09/547,291). The sections below describe the new components, the Rate of Change Analysis Engine (RCAE) and Behavior Driver.

Rate of Change Analysis Engine

Note that as described in the WICA system, the Content Analysis Engine (CAE) returns analyzed search results via the Rateable Search Results database. These results contain potentially many sites, each with its own Rating, Reference Count and Confidence Level. This could form a large body of data. The RCAE can function by accessing the Rateable Search Results database, as described in the WICA system. However, we would like the RCAE to be able to run on a small device, with limited local storage capabilities. Also, the RCAE may not have direct access to this database, as in the Robotic Bird example above (FIG. 4). In this case, the RCAE may receive summary information from the CAE, in the form of Search Result Objects (SROs), as shown in FIG. 2 (which could be provided from any system, not just a WICA system). This method of transmitting results via the SROs is a change from the WICA system, so the Search Result class from the WICA application (Ser. No. 09/54.291) is listed below for reference. The method used to describe data structures and programming logic is based on the Java Programming language, and is the same as the method used in the WICA application (Ser. No. 09/547,291) and this method is described as follows: “Objects” referred to in this document can be thought of as Java Objects (although implementations in other programming languages would be possible), and class definitions are provided using the syntax of the Java programming language. The syntax used is Java with the addition of “Collection” which simply refers to a collection of objects of a given type. It could also be thought of as an array of objects. Also the term “Method” is used in the class definitions which simply indicates that the class would contain a method to do a certain function. The term “String” is used as a data type to denote an arbitrary length text string. The class definitions below are not intended to be the complete definition which would be used in a production system, but to provide enough detail so that a skilled Java programmer could implement the class with the intended results.

Here is the Search Result class (as described in the WICA system):

Class SearchResult {

String SearchResultId; /*Unique identifier for this search—populated by CRE */

String ContentRetrievalObjectID; /*Identifier of the type of the Content Retrieval Object which performed the search.*/

String InformationDimensionDictionaryPath; /*identifies the location of the Information Dimension Dictionary used in the search */

string SearchResultMode; /* Broad or Targeted—populated by CRE*/

string SearchCriteria; /*string defining exactly what the search criteria were (keywords, etc)—populated by CRE*/

string SearchDateTime; /*Time and date the search was performed—populated by CRE */

string SearchResultURL; /*URL indicating where result of search was stored—populated by CRE*/

string TotalMatches; /*Total number of search results returned—populated by CRE*/

Collection (CompositeRatings); /* populated by CAE. The composite rating stored here is the rollup of the analysis of the entire results set returned by this search.*/

}

Here is the CompositeRating class from the WICA system, also reproduced for reference:

Class CompositeRating (

String InformationDimension;

Int Rating;

Int ReferenceCount; (number of RateableUnits the CompositeRating is based on)

Float ConfidenceLevel;

)

SROs do not have to be produced specifically by a WICA system for the RCAE to function. Any system with similar functionality could produce data which could be formatted into SROs and fed to the RCAE. The RCAE produces Behavior Probabilities by comparing Composite Ratings of Search Results over multiple searches. The RCAE can then determine both the direction and the rate of change for a given Information Domain/Subdomain and Information dimension.

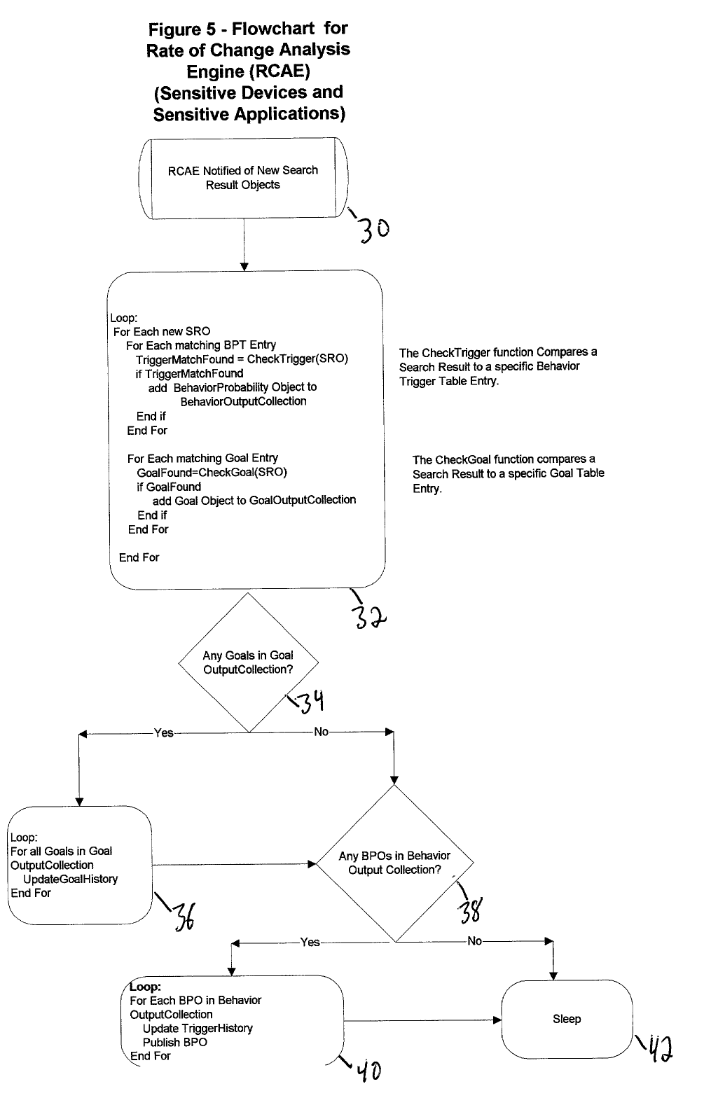

The processing of the RCAE is described in FIG. 5. Following system initialization, RCAE processing is event driven. That is, the RCAE “wakes up” upon being notified that new input is available to analyze. It could be implemented in a Java environment as a thread, which uses the Java synchronization mechanisms (such as the Wait ( ) and Notify ( ). These methods are included in the Java SDK version 1.3.1 (Sun Microsystems) and in the Java 2 Micro Edition (Sun MicroSystems-sponsored Java implementation for small devices such as wireless phones). Upon receiving this notification, the RCAE performs the following steps:

a. For each new Search Result, retrieve Behavior Trigger Table entries relevant to Search Result (table entries with Information Dimensions matching Search Result) (Block 30)

b. Check to see if Trigger Conditions and Goal Conditions have been satisfied for any Behavior Table Entries given new Search Results. This involves comparing data in the current Search Result to the conditions specified in the Behavior Probability Table, and may involve retrieval of previous Search Results if the condition is of type Delta (Block 32). For any Trigger Conditions which have been satisfied, create new Behavior Probability Objects (BPOs) with appropriate Behaviors and Probabilities

c. Update Trigger History and Goal History if any new Behavior Probability Objects were created (ie if any Trigger Conditions were satisfied) (Blocks 34-40)

d. “Publish” BPOs (Block 40)

e. Go to sleep and wait for new Search Results (Block 42).

Note that a “publish and subscribe” mechanism is used by the RCAE for making BPOs available to all components which may be interested in these results. This introduces a broadcast capability, so that multiple Behavior Drivers (and multiple devices) could receive and react to these probabilities.

Below is an outline of the data used by the BehaviorProbabilities Class.

Class BehaviorProbability {

String informationDimension; /*Dimension of Interest for this entry*/

String informationDomain; /*Domain of interest, for-instance, Chess */

String Behavior; /* Behavior to exhibit for-instance “Happy” */

String BehaviorType; /* Behavior type, for-instance “Mood” or “Reaction */

Float BehaviorProbability; /*Probability that this Behavior should be exhibited (used in Behavior Driver “Roll of the dice” */

Int Intensity; /* Intensity of the Behavior */

Int Duration; /* Duration of the Behavior */

SearchResult SearchResult; /* Search Result object which can be used by Behavior Driver to pull content from and send to device in conjunction with Behavior */

String ContentURL; /*URL of Content to send to device and output in conjunction with behavior */

String ContentString; /* String literal to send to device and output in conjunction with behavior */

Int Status; /* Status field which is populated by Behavior Driver for Behaviors which pass “Roll of the dice” and are sent to Behavior Controllers. The status field can indicate success/failure of attempt to activate Behavior. The population of this field turns the Behavior Probability Object into a Behavior Summary Object, which is published by the Behavior Driver and can be used as input to the Content Retrieval Engine, providing a feedback mechanism */

}

Behavior Driver Processing.

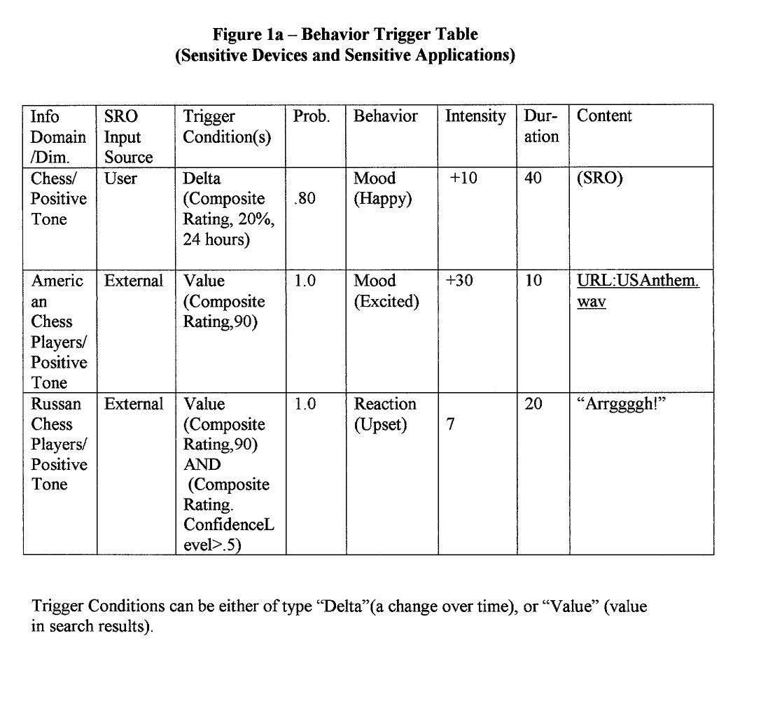

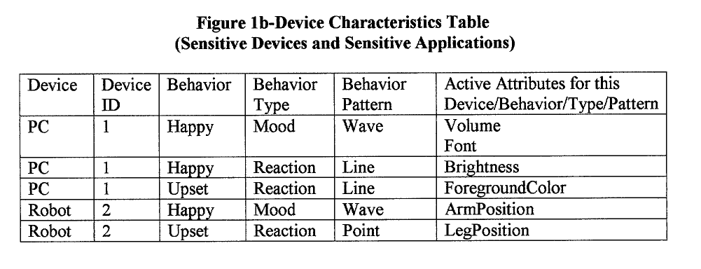

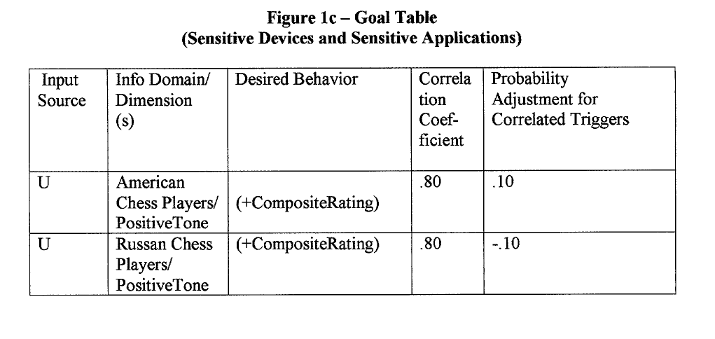

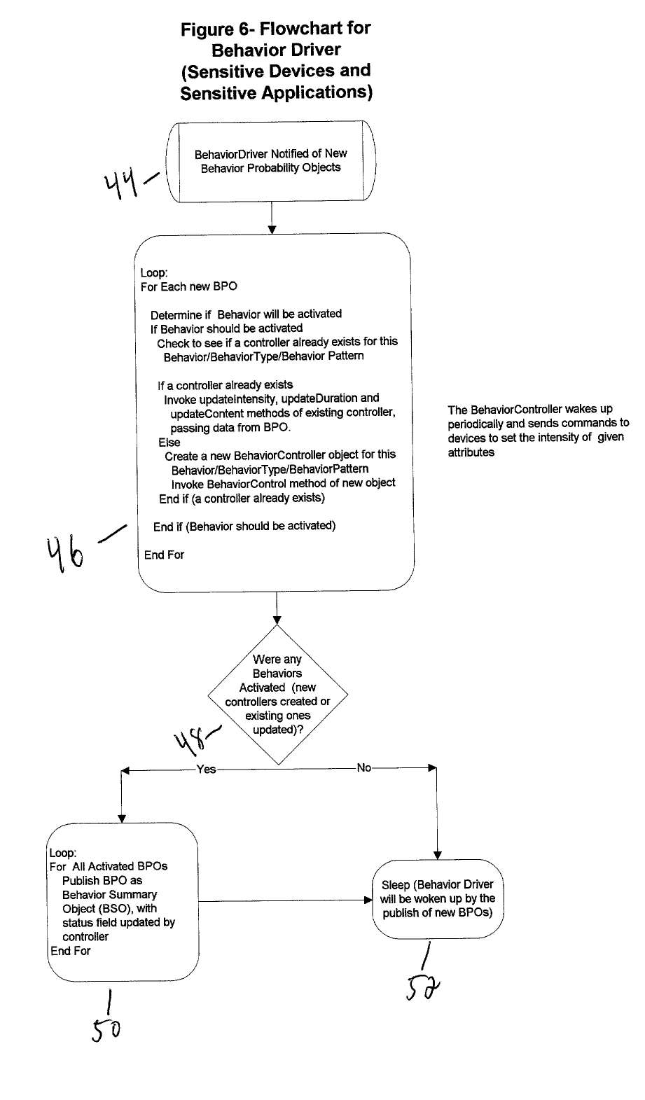

The Behavior Driver Processing is described in FIG. 6. Like the RCAE, the Behavior Driver is event driven. During initialization it “subscribes” to receive Notification of the existence of new Behavior Probability Objects. It wakes up whenever a new Behavior Probability Object is published. Each time the Behavior Driver wakes up, it will invoke examine the new BPOs, and invoke or create Behavior Controllers to set intensity of active device attributes as appropriate. As noted above, the RCAE specifies high level Behaviors as Moods and Reactions (“Happy”, “Upset”, etc) with an associated intensities and durations. The Behavior Driver uses the Device Characteristics Table to map these behaviors to device characteristics. For-instance, the Volume setting on a PC audio subsystem may be associated with the “Anger” Mood. But it is not enough to simply map the Intensity as specified in the BPO to the volume level. In order to simulate human emotion, we want the emotional state to be represented as a series of changes in intensity over the specified duration, so that the emotion builds, flows, ebbs, etc. This is accomplished by mapping emotional states to geometric and mathematical functions via the Device Characteristics Table and associated Classes. Consider a Cartesian coordinate system with the x axis representing time, and the y axis representing Intensity of the given Behavior. This provides an intuitive way to “graph” the progression of an emotional state. We speak of “Waves of emotion”. With this system it is possible to represent emotion as a wave function, with the intensity rising and falling, in for-instance, a Sine Wave pattern over a time period. We refer to functions such as these as Behavior Patterns Figure lc shows a sample Device Characteristics Table, which maps Behaviors such as “Happy Mood” to patterns such as “Wave”. The first entry of this table may be interpreted as follows: For Device ID #1, of type PC, if the BPO specifies a Happy Mood is required, represent this as a Wave pattern and vary the “Intensity” of the device attributes of Volume and Font according to this pattern. One way to implement this pattern would be to make the Intensity in the BPO the amplitude of a sine wave, and to interpret the duration as the period of the wave. This will result in a series of commands to the device to adjust the intensity of each affected attribute over time. In the case of Volume, intensity can simply be mapped to Volume level. In the case of Font, the Intensity can be mapped to a Font Type (1=Arial, 2=Helvetica, etc). Examining table entry 2, we see that for Device ID #1 of type PC, a Happy Reaction is represented by a Line function, with Intensity mapped to Brightness. In this case, the change in Intensity specified in the BPO could occur in gradual increments over the duration, building up the specified Intensity in the BPO. Examining the table Entry for Device Robot, “Upset” Reactions (5), we see the following: For Device ID#2. of type Robot, if the BPO specifies an Upset Reaction, represent this as a Point function (ie a single occurrence of the command to the device, with Intensity mapped to LegPosition.) The system uses Behavior Controller Objects to implement these functions. To implement the Behavior Patterns in FIG. 1c, we would need a WaveController, a LineController and a PointController. The outline of the BehaviorController class (the parent class of the hierarchy) and the LineController class (which extends the BehaviorController class) follows.

Class BehaviorController {

BehaviorProbability SourceBPO; /* The Behavior Probability Object which led to the creation of this controller, or was most recently used to set duration and intensity for this controller. This is needed so we can update the object with the status of device operations invoked to implement the behavior */

Int Intensity; /*The Intensity of the Behavior */

Int Duration; /*The duration of the Behavior.*/

String BehaviorPattern; /* for-instance: “Wave” */

String BehaviorType; /* for-instance “Mood” */

String BehaviorName; /* for-instance “Happy” */

String ContentURL; /* pointer to content which could be delivered along with setting of Behavior attributes (optional), such as, for-instance a wav file or a graphics file. */

String SearchResultURL; /*URL indicating where result of search was stored. This can be used so that content from search results can be passed to device controller for display along with setting of Behavior attributes. Content could be selected randomly from these results to give more variability in device behavior*/

/* get and set functions for all of the above instance variables are included in the class, as well as updateintensity(int x) and updateDuration(int x), which add the value of x to the Intensity and duration, respectively

}/* end class BehaviorController */

Class LineController extends BehaviorController {

/*In addition to the instance variables inherited from BehaviorController, the LineController needs these values, which are specific to line-oriented processing: */

Int xCoordStart; /*The x coordinate of the start of the line (x axis is time) */

Int yCoordStart /*The y coordinate of the start of the line (y axis is Intensity) * /

Int xCoordEnd;

Int yCoordEnd;

Int Slope; /* Slope of the line */

Int yintercept; / y-intercept of the line */

Method BehaviorControl ( ) {

/* this method is present in every Behavior Controller subclass and specifies the manner in which the construct which the class knows about (in this case a line) is implemented. The algorithm for the LineController could be as follows:

Loop for time units 1 to Duration. At every iteration, calculate what the Intensity value for that time slot should be by treating the time slot as the x value and using the input parameters along with the standard linear equation y=mx+b. After finding the correct Intensity call the Set<attribute> function for each attribute specified in Device Characteristics table for each device (for-instance, PC.setVolume(Intensity). If new content has appeared since the last iteration, call the SetContent function for the device as well. Receive status from the device function, and use this status to update the Status field of the source Behavior Probability Object (SourceBPO). (Then the Behavior driver can publish the BPO as a Behavior Summary Object) Then go to sleep until it is time to process the next time slot. */

/* get and set functions for all of the above instance variables are included in the class, as well as updateintensity(int x) and updateDuration(int x), which add the value of x to the Intensity and duration, respectively

}/* end class LineController */

Using the above approach, all types of mathematical functions and geometric figures could be used, and the architecture supports the easy addition of new controllers. The Behavior Controllers do not know the details of how to communicate with the device. They call the appropriate device function to accomplish this (for-instance, to set the volume on a PC speaker system). They know which functions to call based on the Device Characteristics Table. Every device must have a set of classes available to the Behavior driver which know how to set the attributes of the device (for-instance, set the volume on a PC), and deliver Content to the device (an example of content delivery might be, for-instance, a .wav file which will be played at the appropriate volume. So for-instance in the case of a PC and our sample Device Characteristics table, methods must exist within a Class called PC as follows:

PC.SetVolume

PC.SetBrightness

PC.SetFont

PC.SetForegroundColor

PC.DeliverContent( ) /* method for delivery can be based on content type, just as MIME types, associated with applications are used in the web to determine the right way for a browser to output content retrieved from a URL.

These are commonly available functions which can be implemented using the Windows Operating System API (for-instance). If the device is a Robotic device, the functions to manipulate the device (for-instance a robotic arm) will be called in the same manner (for-instance Robot.SetLegPosition in case of table entry five in the Device Characteristics Table.) These types of function which actually do the work of setting attributes for a specific device or delivering content to the device are specific to each device type. These functions are not modified by the invention and are not discussed further here.

So the processing for the Behavior Driver is as follows: Upon receiving notification of new BPOs (Block 44) do the following:

a. For each new BPO, use a random number generator to “roll the dice” and see if the behavior will actually be exhibited given the probability passed in the BPO.

For-instance, if the probability is 0.40 generate a random number between 1 and 10 and if it is less than or equal to 4, activate the behavior (Block 46).

b. For each BPO which need to be processed based on results of step a, retrieve relevant Device Characteristic Table entries (entries where Behavior and Behavior Type match BPO). Form list of Behavior Controllers which must be invoked according to table entries (Block 46).

c. Create appropriate new Behavior Controllers, passing Intensity and Duration, and pointers to Content(optional) from BPOs in constructors, or invoke existing Controllers. There should be only one Behavior Controller for each Behavior Pattern/Behavior Type/Behavior combination. So for-instance, there is only one Wave Controller for Happy Mood. If a controller already exists call the updateintensity, updateDuration and (optionally) updateContent methods for the controller to update Intensity, Duration and Content. Otherwise, create a new Behavior Controller and invoke its BehaviorControl Method (Block 46).

d. Publish Processing Results as Behavior Summary Objects (BSOs, which are BPOs with Status field filled in by Behavior Controller) (Blocks 48-50).

e. Go to sleep and wait for publish of new BPOs (Block 52).

Note also that nothing constrains the type of data being analyzed to be only text. Both the Web-based Information Content Analyzer and the components described here can based on processing and analysis on other types of data, such as audio, graphic or video data.

Goal Oriented Behavior

The Sensitive Application is capable of exhibiting goal oriented behavior. One way this behavior can be accomplished is through an “offline” task which goes through History data looking for correlations between actions taken (ie Triggers activated) and desired outcomes. This search can be implemented using the Goal History and Trigger History described above (updated by the RCAE) in combination with the Goal Table and the Behavior Probability entry in the Behavior Trigger Table. This processing is implemented as follows: The Goal Table is used to describe which Search Results to consider desireable. A sample Goal Table is shown in FIG. 1c.

The first entry of this table may be read as follows: For User Input in the Information Domain of American Chess Players, consider a gain in the Composite Rating for the Information Dimension of Emotional Tone to be a “desireable” thing. That is, if from search to search the input from the User seems to be improving (+Composite Rating) in terms of the tone used towards American Chess players, the goal has been met. An offline task can wake up periodically and look through the Goal History to find all the times this goal has been met. Then it can look through the Trigger History to see if there are any statistical correlations between certain triggers and the meeting of the Goal. If it finds any triggers with a greater than 80% correlation between the Trigger Condition being activated and subsequent meeting of the goal, the probability of that trigger occurring is adjusted upwards. This way the “roll of the dice” described above in the Behavior Driver Processing description will be more likely to yield positive results for those triggers which are correlated with successful outcomes. The probability for these triggers will be adjusted upwards by 10% if the triggers are correlated, according to FIG. 1c. According to the first entry, a trigger is considered to be correlated with the goal if the linear correlation coefficient is greater than 0.80. This example illustrates how standard statistical techniques can be applied to the data in the Trigger History and Goal History tables to adjust outcome probabilities and therefore make the sensitive application “behave” in a goal oriented manner.

### SUMMARY

It is useful at this point to recap examples of the many factors which can be used in determining Device Behavior. These factors include:

a. Ratings of Search Results (obtained by CRE and CAE)

b. Confidence Level in these Search Results (obtained by CRE and CAE)

c. Reference Count for Search Results

d. Behavior Probabilities (calculated by RCAE and modified through analysis of Trigger history and correlation with Goals)

e. Behavior Patterns (specified in Device Characteristics Table and implemented in BehaviorControllers)

Through this combination of elements, the device behavior can be widely varied, yet directed, in a manner which is similar to the range of human subjective responses. For-instance, if the system is set up so that results with a very low confidence level are mapped to major behavior changes with high probabilities, the system will “simulate” the reactions of a highly volatile person, who “flies off the handle” based on only limited information. Mapping high confidence levels to high probabilities will result in more measured, controlled, predictable behavior.

Using the mechanisms described in this invention, the following are all true of Sensitive devices:

a. The same instance of a device can react differently at different times to the same stimulus (depending on its current state, among other things)

b. Different instances of the same device type can have different “personalities”

c. The same instance of a given device type can react differently at different times to the same stimulus.

d. Different emotions can be expressed differently for various devices types (screen saver for happiness, volume for anger, etc).

e. The progession of an emotional state can be reflected (through Behavior Patterns) differently for different devices, device types and emotions (through Behavior Patterns.

f. The “personality” of the device can change over time, as the feedback mechanism (BSOs or other device output provided as input to Content Retrieval Engine), and the goal-oriented behavior mechanism gradually modify the behaviors exhibited by the application.

These capabilities provide a unique new approach to the problem of making computer applications exhibit sensitive, goal-oriented human-like behavior.

Glossary of Terms

Behavior

A description of a human subjective state or reaction. Examples of Behavior are a Happy Mood or an Upset Reaction.

Behavior Controller

A software component which knows how to implement a specific Behavior Pattern. An example would be a Sine Wave Behavior Controller.

Behavior Driver

The subsystem which is responsible for device control. The Behavior Driver uses input from the Rate of Change Analysis Engine to determine which Behaviors should be activated, then translates these Behaviors into specific control instructions understood by the device.

Behavior Pattern

A mathematical or geometrical construct which is used to represent the change in intensity of a Behavior over time. An example would be the use of a Sine Wave Behavior Pattern to represent the change of in intensity of a Happy Mood over time.

Confidence Level

The level of confidence in the validity of the Rating for a given item to be rated.

Content Analysis Engine

The subsystem which analyzes the results returned by the Content Retrieval Engine to determine the Strength of each hit for a particular Information Domain and Information Dimension.

Content Retrieval Engine

The subsystem which formulates the search keys used to search the web for information relating to Information Domains and Information Dimensions. The Content Retrieval Engine also performs the actual search.

Goal

A Boolean function (which may be a compound Boolean) which can be applied to search results to determine if a desired outcome has been achieved. An example would be a goal of a higher than 0.90 Composite Rating in the Information Domain/Dimension of Chess/Positive Tone.

Information Dimension

A particular criteria of interest within an information domain. Information Dimensions usually are measured along a continuum as opposed to being simply present or not present. Examples of Information Dimensions are Size (smallest-largest), Speed (slowest-fastest), Emotional Tone (negative-Positive).

Information Domain

An information topic or category of interest. (Not to be confused with Internet Domains). An Information Domain of interest might be very limited (for-instance “Bill Gates” or cover an entire field (for-instance “Sports”).

Net-Sensitive Application

A Sensitive Application which has access to an external network such as the Internet or an Intranet.

Net-Sensitive Device

A device controlled by a Net-sensitive application.

Rate of Change Analysis Engine

The subsystem which is responsible for analyzing input and determining which Trigger Conditions and Goals have been met based on this analysis.

Rating

A number which indicates the strength of a word or phrase within a particular Information Dimension. For example “Huge” has a high rating within the Information Dimension of Size.

Reference Count

The number of items of information used to determine a Composite Rating for a given site.

Sensitive Application

A software application which gives the impression of working towards goals, reacting “emotionally” and “understanding” feelings.

Sensitive Device

A device controlled by a Sensitive Application.

Trigger Condition

A Boolean function (which may be a compound Boolean) which can be applied to search results and is associated with the activation of a given Behavior.

While a specific embodiment of the invention has been shown and described, it is to be understood that numerous changes and modifications may be made therein without departing from the scope and spirit of the invention as set forth in the appended claims.

What I claim is:

1. A method of controlling a device via a software application, wherein the device could be a Personal Computer, Robot, toy, light or any device which is capable of being electronically controlled, comprising:
a) invoking a Rate of Change Analysis Engine (RCAE), passing it at least one Search Result Object (SRO);
b) Analyzing the SRO(s) and determining a set of Behaviors which should be exhibited based on this analysis;
c) Translating these Behaviors, which may be emotional states, moods or reactions into a set of commands understood by the device(s);
d) Sending these commands to the device.

2. A method of controlling a device, according to claim 1, wherein the search Results obtained in step (a) are generated by a system which provides Ratings of a collection of Search Result within one or more Information Dimensions, allowing the analysis in step (b) to select Behaviors based on these ratings.

3. A method of controlling a device, according to claim 1, wherein not only User Input and External Input but Behaviors exhibited by devices become Search Results available to Content Retrieval Engines, allowing applications to influence each other and allowing implementation of a feedback mechanism in which an application influences itself.

4. A method of controlling a device according to claim 1, wherein in step (b) the determination of Behavior is accomplished through use of a Behavior Trigger Table, in which mathematical formulae can be used to define Triggers for Behavior according to analysis of Search Results, and in which items summarizing the Search Results can be used in these formulae, including items such as Ratings of Search Results within an Information Dimension and Confidence Level in Search Results.

5. A method of controlling a device, wherein the device could be a Robot, toy, light or any device which is capable of being electronically controlled, comprising
a) Using a table which maps Behaviors to mathematical functions, (Behavior Patterns), wherein the mathematical function is used to determine the varying Intensity of a Behavior over a period of time.

6. A method of controlling a device, according to claim 5, wherein the meaning of Intensity may be different for different devices, Behaviors and Behavior Patterns.

7. A method of creating goal-oriented behavior in a software application, comprising:
a) invoking a Rate of Change Analysis Engine (RCAE), passing it at least one Search Result Object (SRO);
b) Analyzing the SRO(s) and determining a set of Behaviors which should be exhibited based on this analysis;
c) Keeping a history of which Behaviors were exhibited (Trigger History) over time;
d) Correlating Behaviors to goals (Goal History);
e) Based on the analysis in step d, increasing the probability of Behaviors which are correlated with achievement of goals.

8. A method of creating goal oriented behavior in a software application, according to claim 7, wherein the application could control a device, such as a Personal computer, robot, toy, light or any device which is capable of being electronically controlled, thereby making the device exhibit goal oriented behavior.

9. A method of simulating emotional states and emotional transitions in a device, wherein the device could be a Personal Computer, a robot, toy, light or any device which is capable of being electronically controlled, comprising:
a) Retrieving User Input, External Input (including input from the Internet or an Intranet) and/or Internal Input and producing Ratings of this input for selected Information Dimensions and Information Domains;
b) Checking Rated input from step (a) against a set of Trigger Conditions, to determine which Behaviors should be manifested based on Ratings in step (a);
c) Sending an appropriate command or series of commands to the device to exhibit the Behavior as determined in step (b).

10. A method of simulating emotional states and emotional transitions in a device, according to claim 9, wherein the Behavior Probabilities are determined in step (b) and Behavior Probabilities associated with Trigger Conditions can be modified during operation, thereby changing the way the device reacts to input over time.

11. A method of controlling a device, according to claim 9, wherein Behavior is represented as an Intensity over a period of time (Duration), and the meaning of Intensity may be different for different devices, Behaviors and Behavior Patterns.

12. A method of controlling a device, according to claim 9, wherein emotional states are represented as device Behaviors, such that:
a) Behaviors can be defined in a Device Characteristics Table and implemented in Behavior Controllers which allow different Behaviors to be expressed differently for different device types.
b) Behavior Patterns can be defined in a Device Characteristics Table and implemented in Behavior Controllers which simulate the progession of an emotional state differently for different devices, device types and emotions.
